(19) United States
(12) Patent Application Publication
(10) Pub. No.: US 2004/0193671 A1
(43) Pub. Date: Sep. 30, 2004

(54) System for implementation of transforms

(75) Inventors: Adrian Stoica, Pasadena, CA (US); Xin Guo, Pasadena, CA (US)

Correspondence Address: Adrian Stoica,Chromatech, 3579 E. Foothill Blvd. #120, Pasadena, CA, 91107, US

(73) Assignees: Adrian Stoica, Pasadena, CA; Xin Guo, Pasadena, CA

(21) Appl. No.: 10/740,399

(22) Filed: Dec. 22, 2003

Related U.S. Application Data
(60) Provisional application No. 60/434,804, filed on Dec. 20, 2002.

(51) Int. Cl. G06G 7/02

(52) U.S. Cl. 708/820

(57) ABSTRACT

A system for efficient implementation of transforms. The implementation by flows of particles, and summation by a conservation low offers savings. In particular for an electronic implementation, a current mode implementation is described, by which replicators, sign changers are implemented by current mirrors and summation is performed in a node by Kirchoff″s law. The transform implementation is efficient for on-chip compression avoiding the need to convert to digital all signals from a sensing array. It is also an efficient implementation for direct control of an emitting array, such as a display which can be directly controlled with outputs from a transform block performing decompression.

### BACKGROUND OF INVENTION

This invention provides an efficient implementation (compact, fast and low-power) of the direct and inverse transforms widely used in modern signal processing. This is an analog implementation which can process continuous or discrete analog signals. Transforms are used to process signals, which may come for example from image sensors, such as imagers, and are a key operation in compression, feature extraction, filtering, or other signal processing tasks. Inverse transforms are used in decompression, and could provide direct control signals to individual pixels of displays or other elements of other form of emitting array systems (such as electromagnetic, thermal, etc). Specifically, this description illustrates the invention for an efficient implementation of the Discrete Cosine Transform (DCT), and its inverse (IDCT).

Digital solutions are widely used to implement transforms and offer high resolution and accuracy in computations. However, an analog solution is justified in applications where it is preferable to trade-off some resolution and accuracy in order to gain speed and reduce power. If incoming signals are analog, for example when signals come from imaging arrays, analog transforms have the advantage that do not need the incoming signals be converted to digital as is required by digital implementations. This can provide great savings by avoiding analog to digital conversion (ADC). Many decisions can be taken from the analog result of the transforms. If results are needed in digital format Digital to Analog Coversions (DAC) may often be needed for only a reduced number of signals. This is the case when only a few coefficients of the transforms are used for further processing, such as in many lossy compression schemes, or in various pattern recognition and discrimination tasks. This advantage of having a reduced number of ADC/DACs becomes even more important as arrays get larger, with more sensing elements. Large number of ADC attract either a power and speed penalty, by fast multiplexing of all signals though one ADC circuit, or a silicon area penalty if several ADC circuits are used in parallel.

Several analog computing solutions were proposed in the literature [6] and patents. All these solutions, use similar circuit implementations in which summations and multiply are performed by circuits using operational amplifiers. Although there are several techniques to reduce the number of multiplies one still needs to perform a large number of sums, which implemented with operational amplifiers results in an expensive solution in terms of silicon area and power. With recent advances in sensing and larger sensors arrays, increasingly more signals from sensors elements are available and their rapid processing, for such applications as feature-recognition-based decision-making or compression for efficient transmission, etc., becomes increasingly demanding, and requires more compact and lower power solutions, in particular for smart sensors, autonomous and space systems, portable devices, sensor networks, antenna arrays, low power display controls; vide-telephones and other wireless devices. Consequently, there exists an unfulfilled need for fast, low power transforms, and uses such as in compression/decompression in a majority of applications.

### SUMMARY OF INVENTION

The present invention provides a system that is an efficient (fast, small and low power) solution to the implementation of transforms used for example in cases where these transforms take input signals from a sensor array and provide coefficients used to compress the information from signals, or take compressed form signals and derive control signals for displays or other array emitting systems. The invention is applicable to cases where signals to process are analog, continuous or discrete.

An object of the invention is to map into a flow graph the operations with variables that enter the mathematical description of the transform, associating each variable to a flow of particles, the summation of two variables with the sum of flows from branches of the graph that meet in a node, and multiplication by a multiplication of flows, and furthermore to have the summation of flows meeting in a node performed by a conservation law. For example, in a specific case the flow of particles may be a flow of electrons, i.e. an electric current, and the conservation law may be a conservation of charge, in this case reducing to Kirchoff″s Law of Currents. Thus, no device or circuit is needed to perform summation in the node, the current that leaves the node is simply equal to the sum of the currents that enter the node due to the conservation of charge in that node. The flow could also be a flow of photons, or light beams, which may be brought together for example by a set of mirrors and combined to an intensity which is the simple sum of the components for two light beams of same wavelength and same phase. Or, the flow could be a flow of other particles, including protons, or neutrons and the conservation law refer to conservation of charge, conservation of mass or conservation of energy.

Another object of the invention is to use replicators, sign changers and multipliers to manipulate the flow. A replicator is used to replicate an incoming flow into two identical outgoing flows. In the case of currents, a replicator provides 2 or more output currents based on an incoming current. This replicator can be implemented with a current mirror. A sign changer changes the direction of flow. For currents, it can also be implemented with a current mirror structure. Two flows, in particular two currents, of opposite directions that meet in the node would generate a result which corresponds to the mathematical difference of the two (a sum of a positive and a negative term). A flow multiplier multiplies the flow by a constant (which could be less than 1, thus implementing a division), or can multiply two currents. In convenient descriptions for linear transforms only products of a variable with a constant are sufficient. However, terms in which more variables are multiplied can be used in implementing a nonlinear transform. Flow multipliers can also be mapped with current mirrors using an appropriate ratio of transistor sizes, and which sum together in the same node, which works for the case of multiplications by constants. Or, multipliers could be implemented with circuits such as Gilbert multipliers.

An additional object of the invention is to decompose a multiplying factor that can not be directly implemented with a simple structure, by means of a decomposition scheme which may partition the factor in several terms, which when added result in the decomposed factor; a compounding addition is afterwards easily implemented by the means described above. For example, a multiplication by m+n (e.g. 2.5=2+0.5) can be implemented by summing a term coming from a multiplication by m (2) and a term coming from a multiplication by n (0.5).

Another object of the invention is to use the described system to map linear transforms such as Fourier Transform, Cosine Transform, etc. or even transforms and signal processing algorithms that are nonlinear which are based on adds and multiplies only, but the multiplies could multiply several variable terms. In general the preferred architectural scheme, or graph would be based on a Fast Transform (e.g. a DCT architecture) which could be optimized to have a minimal number of multiplies, while the adds can be resolved simply by the mechanism proposed here.

Another object of the invention is to use this transform in an apparatus that performs a compression/decompression or control a discriminating circuit that compares analog signals with references for the purpose of doing discrimination and pattern recognition. Operating directly on analog signals from an array of sensing elements (such as an imaging sensor) the transform implementation presented here, in its 2D form, would be a very efficient mechanisms to perform on-sensor compression, with no need for DAC except for a few significant coefficients. Alternatively, decompression (in which the inverse transform would be used) performed in analog would provide the analog signals that could be used to directly control an array of emitting elements, such as an array of display elements or array of antenna elements.

This invention also refers thus to a method of performing an analog transform trough the steps of replicating analog signals that go to more than a node, bringing together analog signals to nodes in which summation is performed by consequence of a conservation law, multiplying analog signals when required by the implementation scheme and repeating the above steps as needed by the implementation scheme.

### BRIEF DESCRIPTION OF DRAWINGS

These and other features, aspects and advantages of the present invention will become better understood with reference to the following description, appended claims, and accompanying drawing, where FIG. 1 shows prior art for a block diagram implementation of a transform, specifically an efficient discrete cosine transform approximation with a reduced number of multiplies and adds.

FIG. 2 shows a selected area of the DCT processing, which contains all types of processing elements and is detailed with the proposed efficient analog implementation. It shows how signals that go to multiple nodes need replication. Replicators can produce multiple outputs of same sign (R)i and replicators with sign change can produce multiple outputs of different sign (RS). A sign changer (SC)changes the direction of the signal flow. Nodes where wires (or other flow paths in general) are brought together sum currents (flows) by conservation law and there are no explicit devices to perform summation. Depending on the case, if a sign change is needed, an optimal implementation may require a combination of R and SC, or an RS, or a combination of R and RS, etc. Currents as inputs or outputs are denoted with 1.

FIG. 3. shows circuit implementations for a sign changer SC, and for a multiplier Mk using current mirrors. Currents are denoted with I and supply voltages with V.

FIG. 4. shows circuits that implement a replicator R and a replicator with sign change RS.

### DETAILED DESCRIPTION

The present invention provides a system that is an efficient (fast, compact and low power) solution to the implementation of transforms used for example in compression, taking signals from a sensor array and providing coefficients, or reversely, in decompression, taking coefficients and deriving signals which can be used for direct control of displays or other array emitting systems. The domain of applcability is limited to cases where inputs are analog signals.

The first step is to map a mathematical description of the transform into a flow graph. The mathematical operations with variables are associated to operations on a flow of particles. For example, the summation of two variables is associated with the sum of flows from branches of the graph that meet in a node, and multiplication by a multiplication of flows.

The summation of flows meeting in a node is performed by a conservation law. For example, in a specific case the flow of particles is a flow of electrons, i.e. an electric current, and the conservation law is a conservation of charge, in this case reducing to Kirchoff″s Law of Currents. Thus, no device or circuit is needed to perform summation in the node, and the current that leaves the node is simply equal to the sum of the currents that enter the node due to the conservation-of charge in that node. The flow could also be a flow of photons, or light beams, which may be brought together for example by a set of mirrors and combined to an intensity which is the simple sum of the components for two light beams of same wavelength and same phase. Or, the flow could be a flow of other particles, including protons, or neutrons and the conservation law refer to conservation of charge, conservation of mass or conservation of energy.

An example is illustrated in relation to FIG. 1. FIG. 1 shows a prior art architectural description of a particular transform, the DCT. One notices the operations in this representation are sums and multiplies; the sums include negative terms, thus implementing effective differences, while the multiplies include sub-unitary terms, implementing divisions.

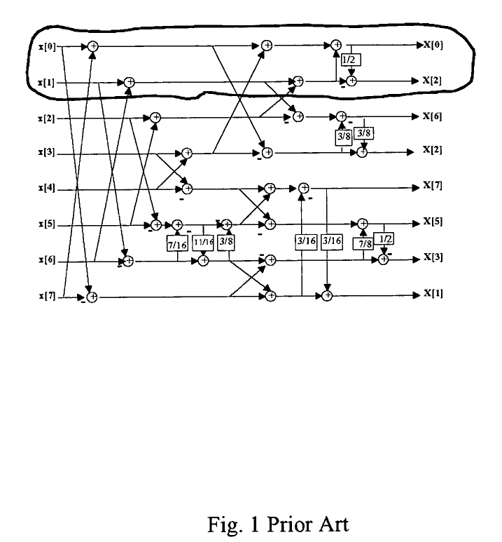

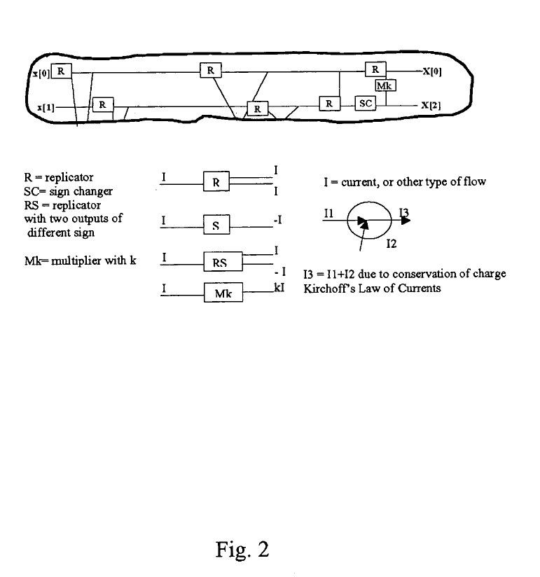

To illustrate the proposed technique one illustrates the implementation on a fragment from FIG. 1, which is reproduced in FIG. 2.

The implementation of the proposed technique makes use of replicators, sign changers and multipliers to manipulate the flow. A simple replicator R is used to replicate an incoming flow into two identical outgoing flows. In the case of currents, a replicator provides 2 or more output currents based on an incoming current. A replicator with sign change RS provides outputs with different signs. For example, for current flows, an RS could have two output currents of different signs. A sign changer SC changes the direction of flow. Two flows, in particular two currents, of opposite directions that meet in the node would generate a result which corresponds to the mathematical difference of the two (a sum of a positive and a negative term).

A flow multiplier multiplies the flow by a constant (which could be less than 1, thus implementing a division), or can multiply two currents. In convenient descriptions for linear transforms only products of a variable with a constant are sufficient. However, terms in which more variables are multiplied can be used in implementing a nonlinear transform.

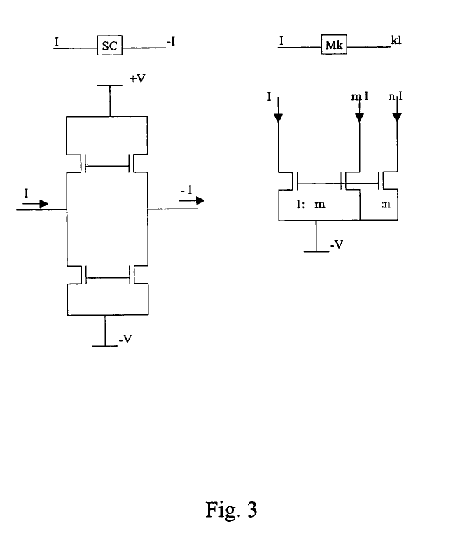

A sign changer SC changes the direction of flow. For currents, it can also be implemented with a current mirror structure as shown in FIG. 3.

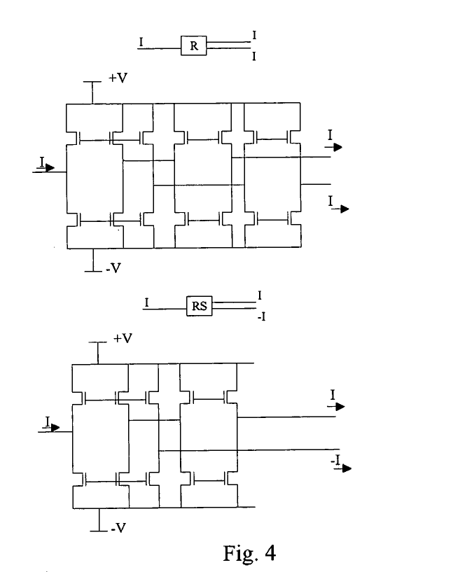

A replicator R can be implemented with a current mirror as shown in FIG. 4.

Flow multipliers can also be mapped with current mirrors using an appropriate ratio of transistor sizes, and which sum together in the same node, which works for the case of multiplications by constants. These is illustrated in FIG. 3. Alternatively, multipliers could be implemented with circuits such as Gilbert multipliers.

An additional object of the invention is to decompose a multiplying factor Mk that can not be directly implemented with a simple structure, by means of a decomposition scheme which may partition the factor in several terms, which when added result in the decomposed factor as shown in FIG. 3; a compounding addition is afterwards easily implemented by the means described above. For example, a multiplication by a number which can be written as m+n (e.g. 2.5 written as 2+0.5), can be implemented by summing a term coming from a multiplication by m (2) and a term coming from a multiplication by n (0.5).

All linear transforms commonly used, including Fourier Transform, Cosine Transform, etc. can be mapped with this method. Moreover, nonlinear transforms and signal processing algorithms based solely on adds and multiplies can be mapped, and the multiplies could multiply several variable terms.

In general the preferred architectural scheme, or graph, would start from a Fast Transform architecture (e.g. a DCT), optimized for minimal number of multiplies, even if at the price of more adds, since the adds can be resolved simply by the mechanism proposed here.

The transform can be used in an apparatus that performs a compression/decompression or controls a discriminating circuit that compares analog signals with references for the purpose of doing discrimination and pattern recognition. Operating directly on analog signals from an array of sensing elements (such as an imaging sensor) the transform implementation presented here, in its 2D form, would be a very efficient mechanisms to perform on-sensor compression, with no need for ADC and with only a few Digital to Analog Converters (DAC) for the few significant coefficients, if a digital output is needed. Alternatively, decompression (in which the inverse transform would be used) performed in analog would provide the analog signals that could be used to directly control an array of emitting elements, such as an array of display elements or array of antenna elements.

Thus, the proposed system is a system of performing a transform through a flow of particles, comprising at least one replicator that replicates flow, and at least one summing node in which the flows through different branches meet and summation is performed by a conservation law. Several replicators are likely to be needed in practical applications since more than one signal enters summing nodes. Several summing nodes are common, each for one addition in the expression of the transform. The flow of particles is selected from the group of electrons, photons, protons, or neutrons. Most likely initial implementations are electronic and optical refering to flows of electrons and photons. The conservation law is a conservation law selected from the group of conservation of charge, conservation of mass and conservation of energy.

At least one sign changer that changes the direction of flow is necessary in implementations where substractions are needed. At least one flow multiplier is needed if transforms still have multiplications or divisions to perform.

The system can perform linear trasforms, including but not limited to Fourier Transforms and Cosine Transoforms, as well as certain nonlinear transforms. In a preferred embodiment the flow of particles is a current of electrons and the summation of currents is performed in nodes where currents meet, by a conservation of charge described by Kirchhoff's Current Law, wherein the replicators that replicate current are implemented with current mirrors.

The preferred embodiment uses at least one sign changer that changes the direction of current flow using a current mirror and replicators that replicate current implemented with current mirrors. At least one flow multiplier implemented with current mirrors of various transistor sizes and which sum together in the same node is used in case where a multiplier is needed. Another embodiment uses at least one flow multiplier implemented with a Gilbert current multiplier. The implementation can be for a general signal processing operation, or in particular for compression and decompression. Compression of analog signals coming from an array of sensing elements is particularly a preferred application. Another area of great potential is where the operation performed is decompression and analog signals from the transform system are used to directly control an array of emitting elements. These could be an array of display elements (e.g LEDs) or an array of antenna elements. In another application the outputs of the transform system can control a discriminating circuit that compares analog signals with references for the purpose of doing discrimination and pattern recognition, for example for an automated target identification system. A particular advantage is seen in enabling on-sensor compression since elimination of analog to digital interfaces and reduced circutry allows the compression to be performed on the sensor chip. In other cases one or more outputs of transform system are used to control analog to digital conversions

A method of performing an analog transform would thus consist of a series of steps, including replicating analog signals that go to more than a node, bringing together analog signals to nodes in which summation is performed by consequence of a conservation law, multiplying analog signals when required by the implementation scheme and repeating the above steps as needed by the implementation scheme.

In conclusion, a flow-based implementation is proposed. Due to the fact that summation is performed by conservation law, there are no active devices needed in the summing nodes. The current mode implementation using current mirrors for replicators, sign changers and multipliers is a much more compact implementation that one with operational amplifiers (and voltage-mode circuitry).

The analog solution proposed here is faster, more compact and low-power than digital implementations. Its advatages are because of savings in ADC/DACs and in the circuitry to implement the transform in analog. The advantage of having a reduced number of ADC/DACs becomes even more important as arrays get larger, with more sensing elements. Large number of ADC attract either a power and speed penalty, by fast multiplexing of all signals though one ADC circuit, or a silicon area penalty if several ADC circuits are used in parallel. On the other hand, the proposed current mode implementation with no active device to implement summation is more efficient than voltage mode methods using operational amplifiers to implement the summation.

1. A system of performing a transform through a flow of particles, comprising:
at least one replicator that replicates flow;
at least one summing node in which the flows through different branches meet and summation is performed by a conservation law.

2. System of claim 1, wherein the said flow is a flow of particles selected from the group of electrons, photons, protons, or neutrons.

3. System of claim 1, wherein the conservation law is a conservation law selected from the group of conservation of charge, conservation of mass and conservation of energy.

4. System of claim 1, further comprising at least one sign changer that changes the direction of flow.

5. System of claim 1, further comprising at least one flow multiplier.

6. System of claim 1, wherein the transform is a linear transform.

7. System of claim 6, wherein the linear transform is selected from the group of Fourier transforms, and cosine transforms.

8. System of claim 1, wherein the flow of particles is a current of electrons and the summation of currents is performed in nodes where currents meet, by a conservation of charge described by Kirchhoff″s Current Law.

9. System of claim 8, wherein the replicators that replicate current are implemented with current mirrors.

10. System of claim 9, further comprising at least one sign changer that changes the direction of current flow using a current mirror.

11. System of claim 10, further comprising at least one flow multiplier implemented with current mirrors of various transistor sizes and which sum together in the same node.

12. System of claim 10, further comprising at least one flow multiplier implemented with a Gilbert current multiplier.

13. An apparatus which employs a transform system as in claim 1 to implement a signal processing operation.

14. The apparatus of claim 13, wherein the signal processing operation is from the group consisting of compression and decompression.

15. The apparatus of claim 14, wherein the operation performed is compression of analog signals coming from an array of sensing elements.

16. The apparatus of claim 14, wherein the operation performed is decompression and analog signals from the transform system are used to directly control an array of emitting elements from the group consisting of array of display elements, and array of antenna elements.

17. The apparatus of claim 13, wherein one or more outputs of the transform system are used to control a discriminating circuit that compares analog signals with references for the purpose of doing discrimination and pattern recognition.

18. The apparatus of claim 15, wherein the compression is performed on the sensor chip.

19. The apparatus of claim 13, wherein one or more outputs of transform system are used to control analog to digital conversions.

20. Method of performing an analog transform comprising the steps of
replicating analog signals that go to more than a node
bringing together analog signals to nodes in which summation is performed by consequence of a conservation law
multiplying analog signals when required by the implementation scheme
repeating the above steps as needed by the implementation scheme.
